(19) United States
(12) Patent Application Publication
(10) Pub. No.: US 2024/0164542 A1
(43) Pub. Date: May 23, 2024

(54) ANTIMICROBIAL ADHESIVE FOR CUSHIONING

(71) Applicant: L&P Property Management Company, South Gate, CA (US)

(72) Inventors: Bruce Peterson, Austin, TX (US); Heidi Stojanovic, Fort Smith, AR (US)

(21) Appl. No.: 18/240,506

(22) Filed: Aug. 31, 2023

Related U.S. Application Data
(60) Provisional application No. 63/384,836, filed on Nov. 23, 2022.

(51) Int. Cl. A47C 31/00; A47C 27/15; C08K 5/00; C08K 5/47; C09J 5/04; C09J 11/06

(52) U.S. Cl. CPC A47C 31/007; A47C 27/15; C08K 5/0058; C08K 5/47; C09J 5/04; C09J 11/06; C08K 2201/005; C09J 2301/408; C09J 2400/226

(57) ABSTRACT

A cushion article comprises an antimicrobial adhesive layer between at least two substrate layers. The antimicrobial adhesive layer includes an antimicrobial additive and an adhesive substrate. The substrate layers are free of the antimicrobial additive within the body of the substrate layer. The method includes providing at least two substrate layers, each substrate layer being free of an antimicrobial additive within the body of the substrate layer. The method further includes applying an antimicrobial adhesive layer to an outer surface of at least one of the two substrate layers. The antimicrobial adhesive layer comprising the antimicrobial additive and an adhesive substrate. The method further includes binding the at least two substrate layers together with the antimicrobial adhesive layer.

### CROSS-REFERENCE TO RELATED APPLICATIONS

This application claims the benefit of priority to U.S. Provisional Patent Application No. 63/384,836 filed Nov. 23, 2022 (pending), the contents of which is hereby incorporated by reference in its entirety.

### TECHNICAL FIELD

The present invention relates to antimicrobial adhesives, more particularly to methods of making antimicrobial adhesives, compositions of antimicrobial adhesives, and uses of antimicrobial adhesives in articles, such as cushions.

### BACKGROUND OF THE INVENTION

Microbes of myriad varieties range from minor nuisances to causes of serious illness in humans. The presence of microbes can be especially prevalent on articles which are shared by many people. The sharing of articles results in not only a high presence of microbes on the article, but also a wide variety due to the varied experiences and exposures each of the article's users may bring with them. To combat the presence of microbes or the growth of microbes on articles of manufacture such as cushions, pillows, bedding, mattresses, and the like, anti-microbial particles have been added during the manufacturing of these articles, in-situ. However, previous manufacturing methods of cushioning articles have required the addition of antimicrobial additives in-situ, which can have negative impacts on a foam resulting from these manufacturing methods including processing of the foam and physical properties of the foam.

In addition, microbes in cushion articles tend to grow on planar surfaces, and particularly in glue seams if a water-based glue had not completely dried and left a humid environment. Furthermore, a targeted administration of antimicrobial additives in select locations may reduce manufacturing costs compared to in-situ administration of antimicrobial additives. This reduction in manufacturing costs may be brought about because the antimicrobial additive would be concentrated in areas that microbes are likely to grow.

Accordingly, there is a need to reduce microbe growth in cushion articles, and particularly in glue seams of cushion articles.

### SUMMARY OF THE INVENTION

Many of the drawbacks and limitations stated above can be resolved by creating novel and advanced interplays of chemicals, materials, adhesives, antimicrobial additives, and other features or designs in a manner that affordably, effectively, conveniently, intelligently, or reliably brings antimicrobial properties to cushion articles.

Embodiments of the disclosed invention are directed to cushion articles having antimicrobial properties. Embodiments of the disclosed invention provide cushion articles having components having antimicrobial effects and are effective at killing microbes and/or inhibiting the growth of microbes in which the components are in proximity to. In various embodiments of the disclosed invention, a cushion article and method of making a cushion article are provided.

Regarding the cushion article, the cushion article includes at least two substrate layers. The cushion article further includes an antimicrobial adhesive layer between the substrate layers. The antimicrobial adhesive layer includes an antimicrobial additive and an adhesive substrate. The substrate layers are free of the antimicrobial additive within the body of the substrate layer.

In some embodiments, at least one of the two substrate layers include flexible polyurethane foam, latex foams, or a combination thereof.

In some embodiments in which at least one of the two substrate layers includes flexibly polyurethane foam, the flexible polyurethane foam may be open-celled, closed-celled, or partially open-celled.

In some embodiments, at least two substrate layers each include flexible polyurethane foam, latex foams, or a combination thereof.

In some embodiments, at least one substrate layer is a latex foam and the latex foam is a natural latex.

In other embodiments, at least one substrate layer is a latex foam and the latex foam is a synthetic latex.

In some embodiments, the adhesive substrate includes a latex, an acrylic, at least two substances that are reactive to each other, or a combination thereof.

In some embodiments, the antimicrobial additive has an average particle size of less than 1 micron.

In some embodiments, the antimicrobial additive has an average particle size of less than 1 nm.

In some embodiments, the cushion article includes the antimicrobial additive in an amount between 0.00000025 wt % of the cushion article and 12.5 wt % of the cushion article, preferably between 0.0000025 wt % of the cushion article and 1.25 wt % of the cushion article.

In some embodiments, the antimicrobial adhesive layer includes the antimicrobial additive in an amount between 5 ppm and 50,000 ppm of the antimicrobial adhesive layer, preferably between 50 ppm and 5,000 ppm of the antimicrobial adhesive layer.

In some embodiments, the cushion article further includes at least a third substrate layer and a second antimicrobial adhesive layer, the second antimicrobial adhesive layer being located between the third substrate layer and at least one other substrate layer.

In some embodiments, the antimicrobial adhesive layer and the second antimicrobial adhesive layer include the antimicrobial additive in the same concentration.

In some embodiments, the antimicrobial additive is selected from a group consisting of butylbenzisothiazolinone, zinc omadine powder or dispersion, benzisothiazolin, a silane quat, 10, 10′-oxybis-1 OH-phenoxarsine, octylisothiazolinone, and combinations thereof.

In some embodiments, the antimicrobial additive includes n-butyl-1,2-benzisothiazolin-3-one.

In some embodiments, the antimicrobial additive includes 2-n-Octyl-4-isothiazolin-3-one.

Regarding the method of making the cushion article, the method includes providing at least two substrate layers, each substrate layer being free of an antimicrobial additive within the body of the substrate layer. The method further includes applying an antimicrobial adhesive layer to a surface of at least one of the two substrate layers. The antimicrobial adhesive layer including the antimicrobial additive and an adhesive substrate. The method further includes binding the at least two substrate layers together with the antimicrobial adhesive layer.

In another embodiment, applying the antimicrobial adhesive layer is performed during post-treatment of the substrate layers.

In another embodiment, the method further includes providing at least a third substrate layer, the third substrate layer being free of the antimicrobial additive within the body of the substrate layer. The method further includes applying the antimicrobial adhesive layer to a surface of the third substrate layer. The method further includes binding the third substrate layer to at least another substrate layer together with the antimicrobial adhesive layer.

In another embodiments, the antimicrobial additive included in the method is selected from a group consisting of butylbenzisothiazolinone, zinc omadine powder or dispersion, benzisothiazolin, a silane quat, 10,10′-oxybis-1 OH-phenoxarsine, octylisothiazolinone, and combinations thereof.

### BRIEF DESCRIPTION OF THE DRAWINGS

The objects and advantages of the disclosed invention will be further appreciated in light of the following detailed descriptions and drawings in which:

FIG. 1 is a cushion article including substrate layers and an antimicrobial adhesive layer of the disclosed invention.

FIG. 2 is a cross-sectional view of at least a portion of the cushion article shown in FIG. 1 showing the substrate layers and an antimicrobial adhesive layer.

FIG. 3 is a cushion article including substrate layers and antimicrobial adhesive layers of the disclosed invention.

FIG. 4 is a cross-sectional view of at least a portion of an alternative cushion article including substrate layers and at least two antimicrobial adhesive layers.

### DETAILED DESCRIPTION OF THE INVENTION

The methods, compositions, and articles taught herein using an antimicrobial additive in an antimicrobial adhesive layer of a cushion article are useful in improving antimicrobial properties of a cushion article in which the antimicrobial adhesive layer is included. These cushion articles may include, but are not limited to, mattresses, pillows, seat cushions, or other cushioning products.

As used herein, the term “antimicrobial” or “antimicrobial additive” is used to refer to a substance that is configured to kill or inhibit the growth of microorganisms such as, but not limited to, fungi, bacteria, viruses, or any combination thereof. Examples of antimicrobials or substances having antimicrobial properties include, but are not necessarily limited to, antibiotics, antibacterials, antivirals, antifungals, antimolds, or other germicides. In preferred embodiments, antimicrobials described herein are configured to provide up to a 99.9% reduction in the number of microorganisms in which the specific antimicrobial is configured to kill or inhibit growth thereof. For example, in a preferred embodiment, the antimicrobial provides up to a log 4 reduction in the number of cells of the microorganism in which the specific antimicrobial is configured to kill or inhibit growth thereof. For example, microbes exposed to the antimicrobial substances described herein that, for example, experience a reduction in number of cells from 10⁸ to 104 would experience a log 4 reduction (i.e. killing of 99.9% of the cells in question). Furthermore, antimicrobials described herein have a rating of less than 1 when measured using the ASTM G-21 test.

As used herein, the term “free”, such as “free of an antimicrobial additive”, is intended to designate the absence of the component identified as being “free”. However, de minimis amounts of the component which is identified as being “free” is included in the meaning of “free”.

As used herein, the term “post-treatment” or “post treatment” is intended to designate a point in time after foam chemicals are mixed and a foam is fully formed.

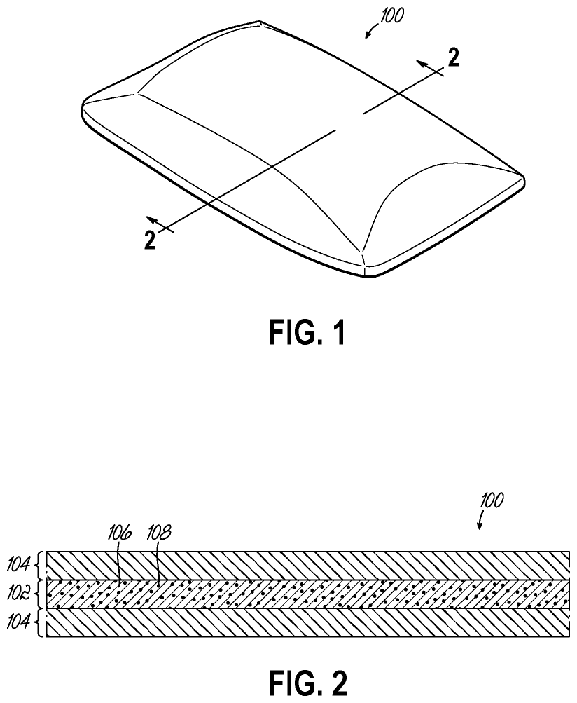

As shown in FIG. 1, a cushion article 100 is provided that includes an antimicrobial adhesive layer 102, and at least two substrate layers 104. Although FIG. 1 shows one configuration of the cushion article 100, the drawings are not intended to be limiting. The cushion article 100 may any other shape or size.

As shown in FIG. 2, a cross-section of the cushion article 100 is shown. FIG. 2 shows that the antimicrobial adhesive layer 102 is positioned between at least two substrate layers 104 and includes an adhesive substrate 106 and an antimicrobial additive 108. The adhesive substrate 106 included in the antimicrobial adhesive layer 102 binds the substrate layers 104 together. The antimicrobial additive 108 provides antimicrobial properties to the antimicrobial adhesive layer 102.

With continued reference to FIG. 2, as described above, a cross-sectional view of the cushion article 100 is shown, focusing on the layers 102, 104 of the cushion article 100. The substrate layers 104 are bound together by the antimicrobial adhesive layer 102, and the antimicrobial adhesive layer 102 is positioned between the substrate layers 104. The substrate layers 104 include any material that is configured to be bound by the antimicrobial adhesive layer 102, and may include materials independently selected from, but not limited to, flexible polyurethane foam, latex foams, bond woven/non-woven fibers, vinyl layer(s), bladder(s), expanded polyethylene, expanded polypropylene, and the like, or a combination thereof. In some examples, the substrate layers 104 are polyether polyurethane foam, polyester polyurethane foam, or combinations thereof. As mentioned, materials included in each of the substrate layers 104 are independently selected. Accordingly, the substrate layer 104 shown in FIG. 2 as a top layer, (i.e. above the antimicrobial adhesive layer 102), may include materials the same as or different from the substrate layer 104 shown in FIG. 2 as a bottom layer (i.e. below the antimicrobial adhesive layer 102). For example, in some embodiments, at least one of the substrate layers 104 shown in FIG. 2 is a flexible polyurethane foam and another substrate layer 104 is also a flexible polyurethane foam. In another embodiment, at least one of the substrate layers 104 shown in FIG. 2 is a flexible polyurethane foam, and another substrate layer 104 is a latex foam. In another embodiment, one of the substrate layers 104 shown in FIG. 2 is a latex foam and another substrate layer 104 is also a latex foam. In some embodiments, at least one of the two substrate layers 104 include flexible polyurethane foam, latex foams, or a combination thereof. In some embodiments, the at least two substrate layers 104 each include flexible polyurethane foam, latex foams, or a combination thereof. In embodiments including flexible polyurethane foam, the flexible polyurethane foam may be open-celled, closed-celled, or partially open-celled in nature. In embodiments including latex foam, the latex foam may be natural or synthetic. These examples are non-exhaustive, and non-limiting.

As shown in FIG. 2, the substrate layers 104 are bound together by the antimicrobial adhesive layer 102, and the antimicrobial adhesive layer 102 is located between the substrate layers 104. The antimicrobial adhesive layer 102 includes an adhesive substrate 106 and an antimicrobial additive 108. In some examples, the adhesive substrate 106 includes, but is not limited to, latex, acrylic, two-component reaction substances, or a combination thereof. In embodiments using two-component reaction substances, the two-component reaction substances may include polyurethane, polyurea, epoxy, or other adhesive that requires an activator, reactant, catalyst, or modifier to produce the desired adhesive substrate 106. In some embodiments, the adhesive substrate 106 includes a water-based substrate, a solvent-based substrate, a substrate of another suitable material for blending with the antimicrobial additive 108, or a combination thereof. Examples of suitable water-based substrates include, but are not limited to, acrylic or latex substrates. Examples of suitable solvent-based substrates include, but are not limited to, toluene, heptane, acetone, amyl acetate, methyl acetate, ethyl acetate, butyl acetate, cellosolve, ethyl cellosolve, xylene, cyclohexane, ethanol, methyl ethyl ketone, methylene chloride, naphtha, mineral spirits and the like, and combinations thereof.

The antimicrobial additive 108 used in the antimicrobial adhesive layer 102 is a product effective at killing or inhibiting the growth of bacteria, mold, fungi, viruses, or a combination thereof and/or is configured to kill or inhibit the growth of bacteria, mold, fungi, viruses, or a combination thereof. The antimicrobial additive 108 may include, but is not limited to, one or more liquids, one or more solids, one or more gels, or a combination thereof. The antimicrobial additive 108 is dissolved in or dispersed throughout the antimicrobial adhesive layer 102, and may be uniformly distributed or non-uniformly distributed throughout the antimicrobial adhesive layer 102. Examples of suitable antimicrobial additives 108 include, but are not limited to, thiazolinones, metal omadine powders or dispersions, thiazolins, phenoxarsines, and combinations thereof. Specific examples of suitable antimicrobial additives 108 include, but are not limited to, butylbenzisothiazolinone, zinc omadine powder or dispersion, benzisothiazolin, a silane quat, 10,10′-oxybis-10H-phenoxarsine, octylisothiazolinone, and combinations thereof. In examples where the antimicrobial additives 108 include butylbenzisothiazolinone, a particularly preferred butylbenzisothiazolinone is n-butyl-1,2-benzisothiazolin-3-one. In examples where the antimicrobial additives 108 include silane quats, a particularly preferred silane quat is 3-(Trimetholyxysilyl) proplydimethyloctadecyl ammonium chloride. In examples where the antimicrobial additives 108 include octylisothiazolinone, a particularly preferred octylisothiazolinone is 2-n-Octyl-4-isothiazolin-3-one.

The size of the antimicrobial additive 108 may be advantageous as well. In general, smaller particle sizes in a greater number would likely be less uncomfortable for users of the cushion article 100 than larger particle sizes in a fewer number. Furthermore, smaller-sized particles in a greater number may have increased surface area when compared to large particles in a smaller number, which may allow for comparatively greater potency for antimicrobial properties. In an embodiment, the antimicrobial additive 108 has an average particle size of less than 1 cm. In an embodiment, the antimicrobial additive 108 has an average particle size of less than 1 mm. In an embodiment, the antimicrobial additive 108 has an average particle size of less than 1 micron. In an embodiment, the antimicrobial additive 108 has an average particle size of less than 1 nm. Furthermore, in an embodiment, all of the antimicrobial additives 108 included in the antimicrobial adhesive layer 102 has a particle size of less than 1 cm. In an embodiment, all of the antimicrobial additives 108 included in the antimicrobial adhesive layer 102 has a particle size of less than 1 mm. In an embodiment, all of the antimicrobial additives 108 included in the antimicrobial adhesive layer 102 has a particle size of less than 1 micron. In an embodiment, all of the antimicrobial additives 108 included in the antimicrobial adhesive layer 102 has a particle size of less than 1 nm. In some embodiments, the antimicrobial additive 108 is included in an amount of between 0.00000025 wt % of the cushion article 100 and 12.5 wt % of the cushion article 100, preferably between 0.0000025 wt % of the cushion article 100 and 1.25 wt % of the cushion article 100. In some embodiments, the antimicrobial adhesive layer 102 includes the antimicrobial additive 108 in an amount between 5 ppm and 50,000 ppm of the antimicrobial adhesive layer 102, preferably between 50 ppm and 5,000 ppm of the antimicrobial adhesive layer 102. In some embodiments, the antimicrobial additive 108 is present in the antimicrobial adhesive layer 102 in a concentration of between 10.76 g/m² (1 g/ft²) and 269.10 g/m² (25 g/ft²).

At least because the antimicrobial additive 108 is included in the antimicrobial adhesive layer 102, the substrate layers 104 may be free of the antimicrobial additive 108 within the body of the substrate layer 104. While there may be slight, or even de minimus, diffusion of the antimicrobial additive 108 into the substrate layers 104 at the surface of the substrate layers 104 in contact with the antimicrobial adhesive layer 102, the concentration of the antimicrobial additive 108 remains almost entirely in the antimicrobial adhesive layer 102. At least one benefit of this orientation is that a separate processing step is avoided during the manufacturing of the substrate layers 104. This separate processing step would ordinarily include adding the antimicrobial additive 108 to the substrate layer 104 in-situ. As a result, the antimicrobial additive 108 would be dispersed throughout the body of the substrate layer 104. Such a dispersion of the antimicrobial additive 108 is disadvantageous because, as explained above, the majority of microbes of which the antimicrobial additive 108 is intended to interact with are located away from the interior of the body of the substrate layer 104. Rather, the majority of microbes of which the antimicrobial additive 108 is intended to interact with tend to grow on planar surfaces, and particularly in glue seams when a water-based glue is used, such as if a water-based glue had not completely dried and left a humid environment. The dispersion of the antimicrobial additive 108 throughout the body of the substrate layers 104 is advantageously avoided in embodiments described herein.

As shown in FIG. 2, the substrate layer 104 is bound to another substrate layer 104 by the antimicrobial adhesive layer 102. As described above. the substrate layers 104 may be the same or different materials from each other. For example, in one embodiment one substrate layer 104 is a flexible polyurethane foam and another substrate layer 104 is also a flexible polyurethane foam. In another embodiment, one of the substrate layers shown in FIG. 2 is a flexible polyurethane foam, and another substrate layer 104 is a latex foam. In another embodiment, one of the substrate layers 104 shown in FIG. 2 is a latex foam and another substrate layer 104 is also a latex foam. In some embodiments, at least one of the two substrate layers 104 include flexible polyurethane foam, latex foams, or a combination thereof. In some embodiments, the at least two substrate layers 104 each include flexible polyurethane foam, latex foams, or a combination thereof. In some embodiments, at least one of the substrate layers 104 is a fabric which may be woven or nonwoven, and may be bound by the antimicrobial adhesive layer 102 to the other substrate layer 104, which may be a woven fabric, a nonwoven fabric, a flexible polyurethane foam, a latex foam, or any other suitable substrate material capable of being bound to the substrate layer 104 by the antimicrobial adhesive layer 102.

As has been described herein, the interface between a substrate layer 104 and an antimicrobial adhesive layer 102 is a possible place for moisture collection, leading to microbe growth such as bacteria and/or fungal growth. Concentrating the antimicrobial additive 108 at this interface inhibits microbe growth in more targeted regions than alternative configurations such as including antimicrobial additives 108 in other portions of the cushion article 100 within a substrate layer 104. Furthermore, generally, adhesive layers in articles, such as cushion article 100, are typically moisture barriers, and substrate layers, such as substrate layers 104, typically vary from being hydrophobic to fairly hydrophilic. Accordingly, typically, the interface between the antimicrobial adhesive layer 102 and the substrate layer 104 will vary in its potential to collect moisture. The open cell nature of foam included in the substrate layer 104 generates air-exchange with motion, however this air movement is mostly terminated at the antimicrobial adhesive layer 102-substrate layer 104 interface. Air-exchange termination leads to moisture accumulation. Hypothetically, having antimicrobial additives 108 in the substrate layer 104 body may, in some instances, adequately inhibit growth of microbes at the referenced interface, however there are a few issues to consider favoring the use of antimicrobial additives 108 in the antimicrobial adhesive layer 102, only. Particularly, including antimicrobial additives 108 in the antimicrobial adhesive layer 102 only leads to:
1. Focused use of the antimicrobial additives 108 where they are most needed;
2. Separation of the antimicrobial additives 108 from the top surface of a bed or topper to increase the gap between the antimicrobial additives 108 and a person (safety margin); and
3. Higher concentration in a thin film (glue application) is expected to have higher growth inhibition at the interface than that of an article having more distributed antimicrobial additives 108 within the substrate layer 104.

Accordingly, and in an embodiment, the antimicrobial additives 108 are present only on the surface of the substrate layer 104, and the interior body of the substrate layer 104 is free of antimicrobial additives 108.

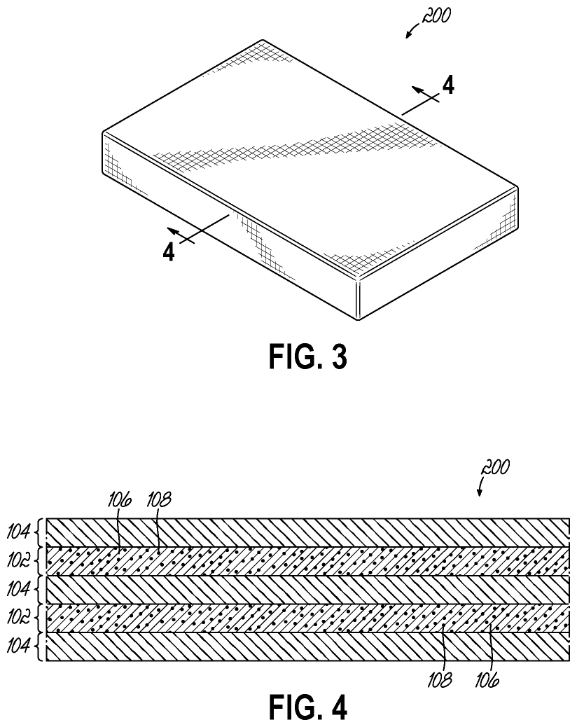

As shown in FIG. 3, a cushion article 200, such as a pillow, is provided that includes a plurality of antimicrobial adhesive layers 102, and at least two substrate layers 104, for example at least three substrate layers 104. Although FIG. 3 shows one configuration of the cushion article 200, the drawing is not intended to be limiting. The cushion article 200 may any other shape or size.

FIG. 4 is a close-up cross-sectional view of another embodiment of the invention. FIG. 4 shows a second antimicrobial adhesive layer 102 and a third substrate layer 104. Embodiments of the invention may include more or fewer of each of the antimicrobial adhesive layer 102 and/or the substrate layer 104. In embodiments of the invention including three or more substrate layers 104, an antimicrobial adhesive layer 104 is located between adjacent substrate layers 104, similar to the cushion article shown in FIG. 4. The antimicrobial adhesive layers 102 each include the antimicrobial additive 108 and the adhesive substrate 106, as described in relation to the embodiment shown in FIG. 2; however, each of the antimicrobial adhesive layers 102 is independent of the other. That is, the antimicrobial adhesive layers 102 shown in FIG. 4 as a top layer, (i.e. above the middle substrate layer 104), may include materials the same as or different from the antimicrobial adhesive layer 102 shown in FIG. 4 as a bottom layer (i.e. below the middle substrate layer 104). In an embodiment, the antimicrobial adhesive layer 102 shown in FIG. 4 as a top layer includes the antimicrobial additive 108 in the same concentration as the antimicrobial additive 108 shown in the antimicrobial adhesive layer 102 shown in FIG. 4 as the bottom layer. Alternatively, though not shown in FIG. 4, the antimicrobial adhesive layer 102 shown in FIG. 4 as a top layer may include the antimicrobial additive 108 in a different concentration as the antimicrobial additive 108 shown in the antimicrobial adhesive layer 102 shown in FIG. 4 as the bottom layer. Furthermore, the adhesive substrates 106 included in each of the antimicrobial adhesive layers 102 are independently selected and do not depend on each other in any way. For example, the adhesive substrates 106 in the top antimicrobial adhesive layer 102 shown in FIG. 4 may include materials that are the same as the materials included as the adhesive substrate 106 shown in the bottom antimicrobial adhesive layer 102 shown in FIG. 4. Alternatively, the adhesive substrates 106 in the top antimicrobial adhesive layer 102 shown in FIG. 4 may include materials that are different from the materials included as the adhesive substrate 106 shown in the bottom antimicrobial adhesive layer 102 shown in FIG. 4. Similarly, the antimicrobial additive 108 included in each of the antimicrobial adhesive layers 102 are independently selected and do not depend on each other in any way. For example, the antimicrobial additive 108 in the top antimicrobial adhesive layer 102 shown in FIG. 4 may include materials that are the same as the materials included as the antimicrobial additive 108 shown in the bottom antimicrobial adhesive layer 102 shown in FIG. 4. Alternatively, the antimicrobial additive 108 in the top antimicrobial adhesive layer 102 shown in FIG. 4 may include materials that are different from the materials included as the antimicrobial additive 108 shown in the bottom antimicrobial adhesive layer 102 shown in FIG. 4.

Methods of producing a cushion article 100, 200 are also provided. An embodiment of a method is described. The method includes providing at least two substrate layers 104, a first substrate layer 104 and a second substrate layer 104. The method further includes applying the antimicrobial adhesive layer 102 to a surface, edge, or combination thereof of at least one of the substrate layers 104. The antimicrobial adhesive layer 102 includes the antimicrobial additive 108 and the adhesive substrate 106. Applying the antimicrobial adhesive layer 102 to a surface, edge, or combination thereof of the substrate layer 104 occurs post-treatment. The method further includes binding the substrate layer 104 having the antimicrobial adhesive layer 102 applied thereto to another substrate layer 104, which may result in the formation of the cushion article 100. As used herein, describing the antimicrobial adhesive layer 102 as being applied “post-treatment” is intended to mean that the antimicrobial adhesive layer 102 is applied to the substrate layer 104 after the substrate layer 104 is fully formed. For example, for substrate layers 104 that are foams, “post-treatment” application of the antimicrobial adhesive layer 102 describes that the antimicrobial adhesive layer 102 is applied to the substrate layer 104 after the substrate layer 104 has formed. In some embodiments, the antimicrobial adhesive layer 102 is applied after fabrication of layered and/or complex parts, such as substrate layer 104, or finished goods, such as cushion article 100, made from foam, fabric, or other components. In some embodiments, post-treatment implies that the antimicrobial adhesive layer 102 is applied to finished foam, not as an in-situ component addition to the chemical blend during foam production.

In another embodiment, the method of producing the cushion article 100 includes providing at least three substrate layers 104. In an embodiment wherein at least three substrate layers 104 are provided, the method further includes applying the antimicrobial adhesive layer 102 to a surface of at least two of the substrate layers 104. Applying the antimicrobial adhesive layer 102 to a surface of the substrate layer 104 occurs post-treatment. In an embodiment, at least three substrate layers 104 are provided, and the third substrate layers 104 are free of the antimicrobial additive 108 within the body of each substrate layer 104. The method may further include applying the antimicrobial adhesive layer 102 to a surface of the third substrate layer 104. The method may further include binding the third substrate layer 104 to at least another substrate layer 104 together with the antimicrobial adhesive layer 108. This process may be repeated to bind additional substrate layers 104 until, for example, the cushion article 100, 200 is formed.

### EXAMPLES

The data included in the following Examples was obtained by following guidelines of the JIX Z 2801 Test for Antimicrobial Activity of Plastics. The JIS Z 2801 method tests the ability of plastics, metals, ceramics and other antimicrobial surfaces to inhibit the growth of microorganisms or kill them. The procedure is very sensitive to antimicrobial activity and has a number of real world applications anywhere from the hospital/clinical environment to a household consumer company concerned with the ability of a material they have to allow bacterial growth.

The JIS Z 2801 method is the most commonly chosen test for determining antimicrobial surface performance, and has become the industry standard for antimicrobial surface performance in the United States. Below, a summary of the JIS Z 2801 test method is described, along with some of its strengths and weaknesses. The JIS Z 2801 test method is designed to quantitatively test the ability of surfaces to inhibit the growth of microorganisms or kill them, over a 24 hour period of contact.

The JIS Z 2801 procedure has been adopted as an International Organization for Standardization (ISO) procedure, ISO 22196.

The test microorganism was prepared by growth in a liquid culture medium. The suspension of test microorganism was standardized by dilution in a nutritive broth (this affords microorganisms the potential to grow during the test).

Control and test surfaces were inoculated with microorganisms, in triplicate, and then the microbial inoculum was covered with a thin, sterile film. Covering the inoculum spreads it, prevents it from evaporating, and ensures close contact with the antimicrobial surface.

Microbial concentrations were determined at “time zero” by elution followed by dilution and plating. A control was run to verify that the neutralization/elution method effectively neutralizes the antimicrobial agent in the antimicrobial surface being tested. Inoculated, covered control and antimicrobial test surfaces were allowed to incubate undisturbed in a humid environment for 24 hours.

After incubation, microbial concentrations were determined. The reduction of microorganisms relative to initial concentrations and the control surface was calculated.

Table 1 tabulates the physical properties of cushion articles of Comparative Examples 1 and 2, as compared to Inventive Examples 1 and 2. Inventive Examples 1 and 2 are cushion articles made by applying the antimicrobial adhesive layer onto the surfaces of the substrate layers during post-treatment manufacturing of the cushion article. In contrast, Comparative Examples 1 and 2 are cushion articles made by applying conventional adhesives between layers, without antimicrobial additives included in the adhesive layers. The only difference between the conventional adhesives used and the antimicrobial adhesive layers used is that the antimicrobial adhesive layers include an amount of the antimicrobial additive.

As shown in Table 1, the “gram positive bacteria” is Staphylococcus aureus and the “gram negative bacteria” is Klebsiella pneumoniae.

TABLE 1
FOAM EXAMPLES

| | | | Antimicrobial | | | | |
|---|---|---|---|---|---|---|---|
| | | | Additive | Gram | Percent | Gram | Percent |
| | | | Content in the | Positive | Improvement | Negative | Improvement |
| | | Coating | Antimicrobial | Bacteria | Compared to | Bacteria | Compared to |
| | Substrate | Thickness | Adhesive Layer | Log | Standard | Log | Standard |
| Product | foam | (g/m²) | (ppm) | Reduction | Adhesive | Reduction | Adhesive |
| Comparative | Visco | 310 | 0 | 1.79 | N/A | 2.43 | N/A |
| Example 1 | | | | | | | |
| (Visco foam | | | | | | | |
| control) | | | | | | | |
| Inventive | Visco | 310 | 1000 | 2.21 | 23% | 2.96 | 22% |
| Example 1 | | | | | | | |
| Comparative | Conventional | 310 | 0 | 1.23 | 0% | 2.83 | 0% |
| Example 2 | | | | | | | |
| (Conventional | | | | | | | |
| foam control) | | | | | | | |
| Inventive | Conventional | 310 | 1000 | 2.51 | 104% | 3.81 | 35% |
| Example 2 | | | | | | | |

As shown in Table 1, cushion articles manufactured according to the invention have improved or comparable antimicrobial activity to comparative cushion articles. However, the improvement of the inventive cushion articles over the comparative cushion articles is that the inventive cushion articles are superior to alternative cushion articles at least because the inventive cushion articles are at significantly more effective at killing microbes and/or inhibiting the growth of microbes.

Particularly, as shown by comparing the data of Comparative Example 1 and Inventive Example 1, the presence of the antimicrobial additives of the present invention shows Inventive Example 1 having a 23% improved antimicrobial activity on visco surfaces compared to adhesives not including antimicrobial additives on visco surfaces. Furthermore, as shown by comparing the data of Comparative Example 2 and Inventive Example 2, the presence of the antimicrobial additives of the present invention shows Inventive Example 2 having a 104% improved antimicrobial activity on conventional surfaces compared to adhesives not including antimicrobial additives on conventional surfaces.

Although not described in detail herein, other steps which are readily interpreted from or incorporated along with the disclosed embodiments shall be included as part of the invention. The embodiments that have been described herein provide specific examples to portray inventive elements, but will not necessarily cover all possible embodiments commonly known to those skilled in the art.

What is claimed is:

1. A cushion article comprising:
at least two substrate layers; and
an antimicrobial adhesive layer between the at least two substrate layers, the antimicrobial adhesive layer comprising:
an antimicrobial additive; and
an adhesive substrate,
wherein the at least two substrate layers are free of the antimicrobial additive.

2. The cushion article of claim 1, wherein at least one of the at least two substrate layers comprise flexible polyurethane foam, latex foams, or a combination thereof.

3. The cushion article of claim 1, wherein at least one of the at least two substrate layers comprise flexible polyurethane foam, and the flexible polyurethane foam is open-celled, closed-celled, or partially open-celled.

4. The cushion article of claim 1, wherein the at least two substrate layers each comprise flexible polyurethane foam, latex foams, or a combination thereof.

5. The cushion article of claim 1, wherein at least one of the at least two substrate layers is a latex foam and the latex foam is a natural latex.

6. The cushion article of claim 1, wherein at least one of the at least two substrate layers is a latex foam and the latex foam is a synthetic latex.

7. The cushion article of claim 1, wherein the adhesive substrate comprises a latex, an acrylic, at least two substances that are reactive to each other, or a combination thereof.

8. The cushion article of claim 1, wherein the antimicrobial additive has an average particle size of less than 1 micron.

9. The cushion article of claim 1, wherein the antimicrobial additive has an average particle size of less than 1 nm.

10. The cushion article of claim 1, wherein the cushion article comprises the antimicrobial additive in an amount between 0.00000025 wt % of the cushion article and 12.5 wt % of the cushion article.

11. The cushion article of claim 1, wherein the antimicrobial adhesive layer comprises the antimicrobial additive in an amount between 5 ppm of the antimicrobial adhesive layer and 50,000 ppm of the antimicrobial adhesive layer.

12. The cushion article of claim 1, further comprising at least a third substrate layer and a second antimicrobial adhesive layer, the second antimicrobial adhesive layer being located between the third substrate layer and at least one other substrate layer.

13. The cushion article of claim 12, wherein the antimicrobial adhesive layer and the second antimicrobial adhesive layer include the antimicrobial additive in the same concentration.

14. The cushion article of claim 1, wherein the antimicrobial additive is selected from a group consisting of butylbenzisothiazolinone, zinc omadine powder or dispersion, benzisothiazolin, a silane quat, 10,10′-oxybis-10H-phenoxarsine, octylisothiazolinone, and combinations thereof.

15. The cushion article of claim 1, wherein the antimicrobial additive comprises n-butyl-1,2-benzisothiazolin-3-one.

16. The cushion article of claim 1, wherein the antimicrobial additive comprises 2-n-Octyl-4-isothiazolin-3-one.

17. A method comprising;
providing at least two substrate layers, each substrate layer being free of an antimicrobial additive;
applying an antimicrobial adhesive layer to a surface of at least one of the two substrate layers, the antimicrobial adhesive layer comprising the antimicrobial additive and an adhesive substrate; and
binding the at least two substrate layers together with the antimicrobial adhesive layer.

18. The method of claim 17, wherein the applying the antimicrobial adhesive layer is performed during post-treatment of the substrate layers.

19. The method of claim 17, wherein the method further comprises:
providing at least a third substrate layer, the third substrate layer being free of the antimicrobial additive;
applying the antimicrobial adhesive layer to a surface of the third substrate layer; and
binding the third substrate layer to at least another substrate layer together with the antimicrobial adhesive layer.

20. The method of claim 17, wherein the antimicrobial additive is selected from a group consisting of butylbenzisothiazolinone, zinc omadine powder or dispersion, benzisothiazolin, a silane quat, 10,10′-oxybis-1 OH-phenoxarsine, octylisothiazolinone, and combinations thereof.
